(19) United States
(12) Patent Application Publication
(10) Pub. No.: US 2007/0073965 A1
(43) Pub. Date: Mar. 29, 2007

(54) Direct storage and retrieval of multimedia data using a data storage device

(76) Inventor: Yasantha Nirmal Rajakarunanayake, San Ramon, CA (US)

Correspondence Address: MCANDREWS HELD & MALLOY, LTD, 500 WEST MADISON STREET, SUITE 3400, CHICAGO, IL, 60661, US

(21) Appl. No.: 11/237,126

(22) Filed: Sep. 28, 2005

(51) Int. Cl. G06F 12/00

(52) U.S. Cl. 711/112

(57) ABSTRACT

Herein described is a system and method of directly storing and retrieving data using a multimedia recording device. The method comprises storing multimedia data into a data storage device without using processor memory associated with said multimedia recording device. The method comprises retrieving the multimedia data from the data storage device without using processor memory associated with said multimedia recording device. The system comprises a multimedia recording device for receiving the multimedia data and a data storage device for storing the multimedia data. The multimedia data is written into and read from the data storage device without using processor memory associated with the multimedia recording device.

### CROSS-REFERENCE TO RELATED APPLICATIONS/INCORPORATION BY REFERENCE

Not Applicable.

### FEDERALLY SPONSORED RESEARCH OR DEVELOPMENT

Not Applicable.

### MICROFICHE/COPYRIGHT REFERENCE

Not Applicable.

### BACKGROUND OF THE INVENTION

When multimedia data streams are received and processed by a digital video recorder (DVR) or set-top box, they are recorded live to a hard disk drive, and are subsequently played back later from the hard disk drive. Currently, the task of recording the multimedia data is achieved by transporting the received multimedia data into main memory associated with a host processor (central processing unit (CPU)), before the multimedia data is subsequently stored into the hard disk drive. Similarly, the task of playing back or reading the stored data is accomplished by storing the data into the main memory associated with the host processor before transmitting the data to a decoder. In this fashion, the main memory serves as a data buffer. The decoder subsequently transmits the decoded data to a display. Additionally, valuable CPU memory resources and CPU bandwidth are utilized when transferring the multimedia data into and out of the main memory in a timely manner. As a result, these valuable resources are unavailable for other tasks and/or applications.

FIG. 1 is a system block diagram of a typical digital video recorder (DVR) employing a magnetic hard disk drive 116 to store multimedia data received from a multimedia service provider. The DVR comprises a transport demultiplexer 104, a processor (e.g., CPU of the DVR) 108, a memory (or processor memory) 112, a hard disk drive 116, and a decoder 120. Also illustrated are a number of command/control signals used for communicating messages between the components of the DVR. As shown, one or more multimedia feeds are received from one or more service providers. Each multimedia feed comprises a multimedia data stream. The multimedia data stream may provide audio-visual programming to a user. In a representative embodiment, the multimedia stream may comprise one or more audio programs provided to the user. The hard disk drive 116 comprises an interface 124 used for transmitting and receiving the command/control signal(s) and multimedia data to and from the processor 108 and processor memory 112. The transport demultiplexer 104 demultiplexes the incoming multimedia data stream into one or more multimedia programs. The processor 108 and the memory 112 further process these one or more multimedia programs. The processor 108 utilizes the resources of the memory 112 to process the received multimedia data, resulting in reduced CPU availability and reduced processor memory bandwidth. The memory (processor memory) 112 may act as a buffer memory or data buffer for facilitating the transport of the one or more multimedia programs to the hard disk drive 116. The memory 112 may comprise main memory used by the processor 108 of the DVR. The memory (or processor memory) 112 may comprise any type of random access memory such as DDR SDRAM memory used by the processor 108. The data that is processed by the processor 108 is transmitted to the hard disk drive 116 for storage by way of the interface 124. The processor 108 may provide control of the transport demultiplexer 104 and the hard disk drive 116 by way of one or more control/command signals. When data is read out from the hard disk drive 116, the data is transmitted through the memory 112, such that additional processing and memory resources are used. The data is transported through the bus and to the decoder 120 where the data is decoded as necessary, and subsequently displayed. The decoder 120 and the processor 108 may communicate by way of control/command signals, such that the data flow rate to the decoder is optimal. The bus may comprise any number of lines such that the data and any synchronization and clocking signals may be adequately transmitted to the components of the DVR.

The limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Various aspects of the invention provide at least a system and a method of directly storing and retrieving data using a digital video recorder (DVR) or one or more DVR capable devices. The various aspects of the invention are substantially shown in and/or described in connection with at least one of the following figures, as set forth more completely in the claims.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 is a system block diagram of a typical digital video recorder (DVR) employing a magnetic hard disk drive to store multimedia data received from a multimedia service provider.

FIG. 2 is a system block diagram of a multimedia recording device utilizing the direct storage and retrieval method in accordance with an embodiment of the invention.

FIG. 3 is a system block diagram of a data storage device for use in distributed multimedia recording device applications, in accordance with an embodiment of the invention.

FIG. 4 is an operational flow diagram describing a direct storage methodology used by a multimedia recording device, in accordance with an embodiment of the invention.

FIG. 5 is an operational flow diagram describing a direct retrieval methodology used by a multimedia recording device, in accordance with an embodiment of the invention.

FIG. 6 is an operational flow diagram describing a direct storage methodology used in a distributed multimedia recording device application, for the system embodiment described in reference to FIG. 3, in accordance with an embodiment of the invention.

FIG. 7 is an operational flow diagram describing a direct retrieval methodology used in a distributed multimedia recording device application, for the system embodiment described in reference to FIG. 3, in accordance with an embodiment of the invention.

### DETAILED DESCRIPTION OF THE INVENTION

Aspects of the invention provide at least a system and a method of directly storing data into and directly retrieving data from a data storage device. The data storage device may be incorporated within a multimedia recording device. The multimedia recording device may comprise a digital video recorder (DVR), for example. Furthermore, aspects of the invention provide a method and system of providing distributed and/or portable data storage functionality to one or more multimedia recording capable devices that are communicatively coupled to a data storage device. For example, one or more DVR capable devices may use the data storage device as a common storage facility. The data storage device may be communicatively coupled to one or more multimedia recording capable devices by way of using one or more communication protocols and a specialized interface. In this way, the data storage device may serve as a centralized storage facility for implementing a distributed multimedia recording device application. One or more multimedia service providers may provide multimedia data to a DVR, DVR capable device, or the one or more other multimedia recording devices. The service providers may comprise a satellite operator or cable operator, for example. The data storage device may comprise a magnetic hard disk drive or an optical drive. The optical drive may comprise a DVD or CD reader/writer. The DVR capable devices may comprise a DVR capable television set, for example. The one or more multimedia recording devices may comprise a digital video camcorder, for example.

By utilizing the system and method, a host processor or central processing unit (CPU) is relieved of performing a number of processing steps when a DVR either writes or reads data into the data storage device. The CPU is relieved of the processing steps of storing data into a main memory of the CPU, which functions as a buffer memory, when data is received from a service provider and stored into the disk drive or data storage device. The buffer memory functions as a data buffer when the data is transmitted to the data storage device. Likewise, the CPU is relieved of using the main memory as a data buffer when data is read from the data storage device. As a consequence, valuable CPU resources and memory resources may be applied to other processing tasks.

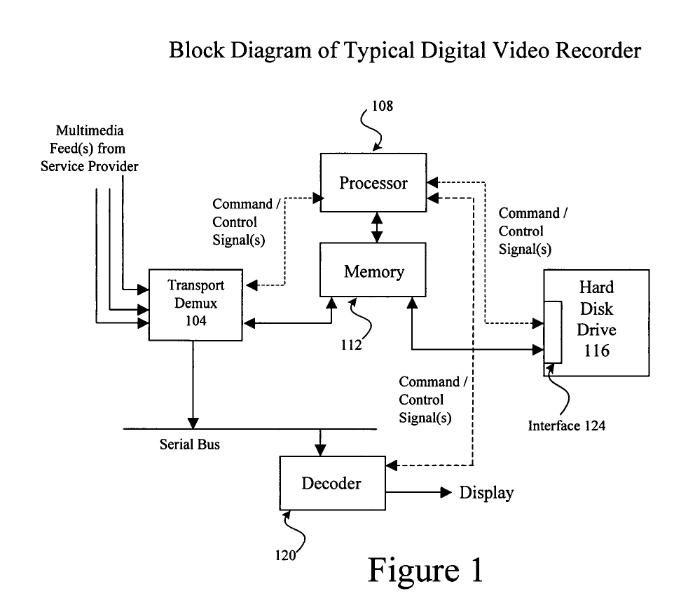

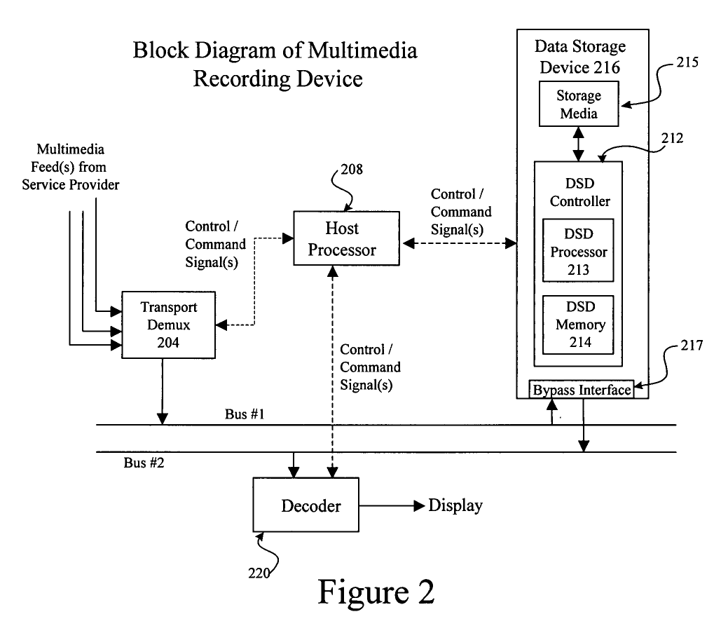

FIG. 2 is a system block diagram of a multimedia recording device utilizing the direct storage and retrieval method in accordance with an embodiment of the invention. The multimedia recording device is used to store and playback one or more multimedia programs. The one or more multimedia programs may comprise any type of audio-visual data that may be viewed and/or heard by a user. The one or more multimedia programs may be transmitted from a service provider, such as a cable TV operator, for example. The multimedia recording device may comprise a digital video recorder (DVR) or personal video recorder (PVR). As shown in FIG. 2, the system comprises a transport demultiplexer 204, a host processor (e.g., a CPU) 208, a data storage device (DSD) 216, and a decoder 220. The data storage device (DSD) 216 comprises a DSD controller 212, a bypass interface 217, and a storage media 215. The DSD controller 212 comprises a DSD processor 213 and a DSD memory 214. The bypass interface 217 may be used as a data interface for transmitting and receiving data to and from the two data buses (bus #1 an bus #2), as shown in FIG. 2. In a representative embodiment, the one or more buses (bus #1 and bus #2) may comprise serial buses and/or parallel buses. The bypass interface 217 may provide connectivity to any type of serial and/or parallel buses. The bypass interface 21 7 is used for providing a direct path to the transport demultiplexer 204. Use of the bypass interface 217 obviates the need for transmitting and receiving through a typical interface that connects the data storage device 216 to a processor memory. In representative embodiments, the DSD 216 may comprise a magnetic hard disk drive or a DVD read/write drive, for example. In a representative embodiment, the DSD 216 may be attached or configured to the multimedia recording device such that the DSD 216 is easily replaced when it is necessary. In a representative embodiment, the DSD processor 213 is used to execute firmware resident within the DSD memory 214. The DSD memory 214 may comprise a non-volatile memory, such as a flash memory. The DSD memory 214 may also act as a data buffer for any data received by the data storage device 216. As illustrated one or more multimedia feeds are received from a service provider. The service provider may comprise a telecommunications carrier such as a cable operator or satellite operator. Each of the one or more multimedia feeds may comprise a number of multimedia programs. The transport demultiplexer (“transport demux”) 204 demultiplexes or selects the one or more feeds and programs. The transport demultiplexer 204 may be involved with tuning and demodulating the incoming one or more multimedia feeds. The demultiplexed output is provided directly to the data storage device 216 by way of bus #1 (as shown). As shown, the demultiplexed output is not stored into a memory (or processor memory) associated with the host processor 208. Bus #1 may comprise any number of lines used for transmitting program data, synchronization signals, and clocking signals to the DSD 216. The DSD controller 212 may comprise circuitry used for properly receiving the data and/or signals provided by bus #1. The DSD controller 212 may comprise a transducer that is used for physically reading from or writing to the storage media 215. The circuitry may work in conjunction with the DSD processor 213 and DSD memory 214 to receive and store the program data into the storage media 215. The firmware in the DSD memory 214 may be executed to facilitate the storage of the one or more demultiplexed multimedia data feeds directly into the DSD 216, obviating the need for resources typically provided by the host processor 208 and its associated main memory or buffer memory. In comparison to FIG. 1, main memory (used by a processor) is not used as a data buffer for buffering the multimedia data, prior to storing it into the data storage device 216; as a consequence, the main memory may be used for other tasks or applications. The host processor 208 may provide control/command signal(s) for controlling the DSD controller 212 such that the program data may be properly stored into the storage media 215 of the DSD 216. Furthermore, the host processor 208 may provide control/command signal(s) for controlling the transport demultiplexer 204. When a program is to be displayed to a user, the program may be read from the storage media 215 using the DSD controller 212. The data that is read is transmitted though bus #2 as shown in FIG. 2. Bus #2 may comprise any number of lines used for transmitting the data and also includes any synchronization and clocking signals provided by the DSD 216. The data is directly transported to the decoder 220 by way of bus #2 such that the program is appropriately decoded and displayed to the user. The data is transported to the decoder 220 by bypassing the memory used by the processor. The host processor's memory is not used as a data buffer. In a representative embodiment, the decoder 220 is used to decompress compressed MPEG such that the data may be visualized using a display. Control/command signals may be used between the host processor 208 and decoder 220 such that the data flow rate to the decoder 220 may be adjusted. The decoder 220 may decode or decompress MPEG data, for example. The aforementioned control/command signals may comprise bidirectional signals.

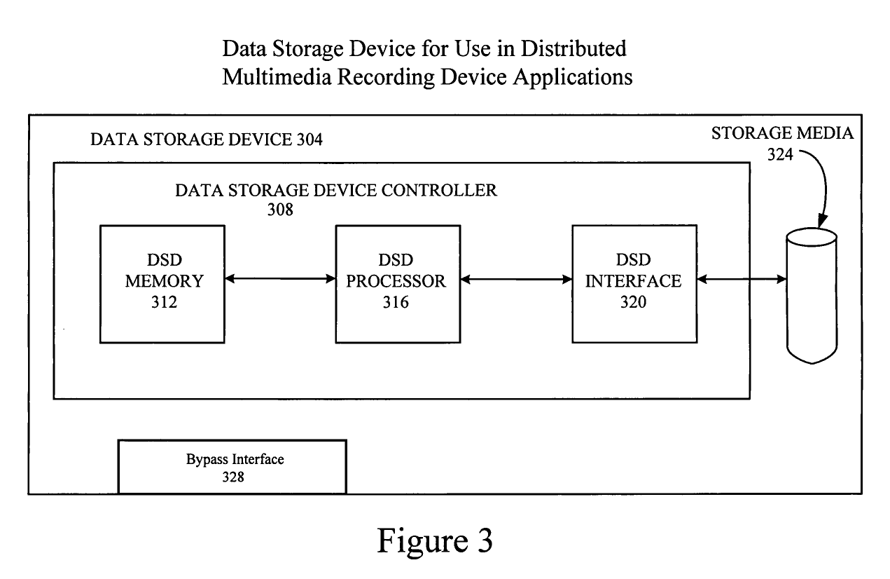

FIG. 3 is a system block diagram of a data storage device 304 for use in distributed multimedia recording device applications, in accordance with an embodiment of the invention. The data storage device 304 provides a bypass interface 328 that is used to connect and provide centralized storage to one or more multimedia recording capable devices. The one or more multimedia recording capable devices may comprise one or more DVR capable devices, for example. The data storage device 304, by way of the bypass interface 328, facilitates a direct mechanism for storage and retrieval of data to and from the data storage device 304. Although not shown in FIG. 3, data received by one or more demultiplexers/tuners/demodulators (i.e., receivers) of the one or more multimedia recording capable devices is sent to the data storage device 304 by way of one or more buses, as was previously described in FIG. 2. The buses may comprise one or more serial and/or parallel type of data buses. Although not shown in FIG. 3, data that read from the data storage device 304 is sent to one or more decoders resident in each of the one or more multimedia recording capable devices by way of the one or more buses. In the representative embodiment of FIG. 3, the associated storage and retrieval methods obviate the use of a processor's main memory as a data buffer. A distributed DVR application, for example, may utilize a one or more DVR capable devices, such as DVR capable television sets, that are connected to a data storage device (DSD) 304. Each of the one or more DVR capable devices may not provide data storage capability. However, each of the one or more DVR capable devices employs necessary bypass circuitry (e.g., buses for bypassing the processor's main memory) to implement the direct storage and retrieval of data to and from the data storage device 304. The data storage device 304 provides a centralized storage facility for the DVR capable television sets. Each of the DVR television sets may be networked into the data storage device using one of many communication protocols. The DVR capable television sets may be located in various locations and may communicate to the data storage device 304 by way of the Internet. A distributed multimedia recording device application may comprise one or more portable video camcorder devices connected to a data storage device 304. The data storage device 304 provides a centralized storage facility for the portable video camcorder devices. Each of the portable video camcorder devices may be networked into the data storage device using one of many communication protocols. Again, the portable video camcorder devices may be located in various locations and may be communicatively coupled to the data storage device 304 by way of the Internet. As illustrated in FIG. 3, the data storage device 304 comprises a data storage device controller 308, a storage media 324, and the bypass interface 328. The data storage device 304 may comprise a portable and self-powered unit capable of reading and writing data into the storage media 324. The data storage device controller 308 may comprise a DSD memory 312, a DSD processor 316, and a DSD interface 320. The DSD memory 312 may be used to store executable firmware that is used for properly processing the received multimedia data feeds. The DSD memory 312 may be used as a data buffer to receive the multimedia data feeds, prior to storing the data into the storage media 324. The DSD memory 312 may be also used as a data buffer to hold data that is read from the storage media 324. The firmware may facilitate the implementation of the data buffer. The DSD processor 316 may provide execution of the firmware and control of the one or more processes performed within the data storage device 304. As shown, the DSD processor communicates to the DSD memory 312 and to the DSD interface 320. The DSD processor may comprise any type of digital signal processing circuitry. The DSD interface 320 may comprise a transducer capable of converting electrical signals into physical read and write operations such that data may be properly read from or written into the storage media 324. The DSD interface 320 may comprise necessary electronics used for reading and writing to and from the storage media 324. The DSD interface 320 may be controlled by execution of the firmware resident in the memory 312. In a representative embodiment, the data storage device 304 comprises a portable hard disk drive and the storage media 324 comprises a magnetic disk drive media material capable of reading or storing data blocks or data symbols when a read/write head performs a read or write operation, respectively. In this embodiment, the data blocks may be indexed by way of using cylinder, head, sector, and offset information. In an alternative representative embodiment, the data storage device 304 comprises a portable DVD reader/writer (or another type of optical reader/writer) and the storage media 324 comprises a DVD (or like optical disk) capable of reading or storing data symbols when a read or write operation is performed, respectively. The bypass interface 328 may comprise one or more connectors. Each connector may comprise any number of electrically conductive pins. The bypass interface 328 may provide the necessary connectors to receive the multimedia data feeds received by the data storage device 304. Optionally, the bypass interface 328 may provide the necessary connectors to receive command/control signals provided by one or more multimedia recording capable devices. The multimedia data feeds and command/control signals may be provided by one or more DVR capable televisions sets, for example. The multimedia data feeds and the command/control signals may be transmitted by way of control provided by a processor located in each of the DVR capable television sets. The bypass interface 328 may conform to a communication protocol or standard. For example, the bypass interface 328 may comprise a type of interface that provides or supports one or more types of wireline or wireless communication protocols, such as IEEE 802.3x, Bluetooth, and/or 802.11x. A network interface such as IEEE 802.3x may be used to implement the distributed DVR capable television or distributed multimedia recording device implementations. Alternatively, the bypass interface 328 may comprise one or more IEEE 1394 compliant connectors, one or more USB compliant connectors, or one or more types of serial and/or parallel connectors. The IEEE 1394, USB, or serial/parallel connectors may be used to provide data and/or command/control signal connectivity to one or more portable multimedia recording capable devices that utilize the corresponding mating connectors. When using the serial/parallel connectors, serial and/or parallel data may be transmitted to the one or more demultiplexers/tuners/demodulators (i.e., receivers) of the one or more multimedia recording capable devices by way of using serial and/or parallel type of data buses.

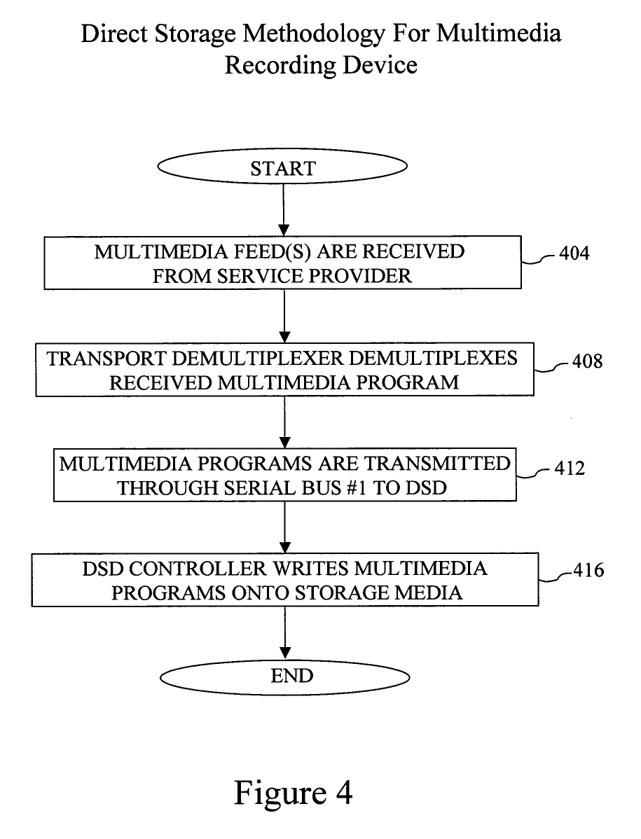

FIG. 4 is an operational flow diagram describing a direct storage methodology used by a multimedia recording device, in accordance with an embodiment of the invention. The multimedia recording device may comprise a digital video recorder (DVR), for example. At step 404, one or more multimedia data feeds are received from a service provider. The service provider may comprise a cable operator or satellite operator, for example. Next, at step 408, the transport demulitplexer tunes, demodulates, and demultiplexes the one or more received multimedia data feeds. At step 412, the one or more demultiplexed programs are transmitted through a bus (i.e., bus #1) to a data storage device (DSD). The data storage device uses its DSD controller to write the multimedia data into the storage media. The DSD controller may execute firmware to facilitate writing of the multimedia data into the storage media. The firmware may reside within a DSD memory of the DSD controller. The multimedia data may be stored in the DSD memory before being stored into the storage media. The DSD memory may function as a buffer memory for receiving the incoming multimedia data from the bus. Next, at step 416, the DSD controller writes the received multimedia data onto the storage media. The DSD controller may utilize interface electronics and a write transducer, such that writing of data may properly occur.

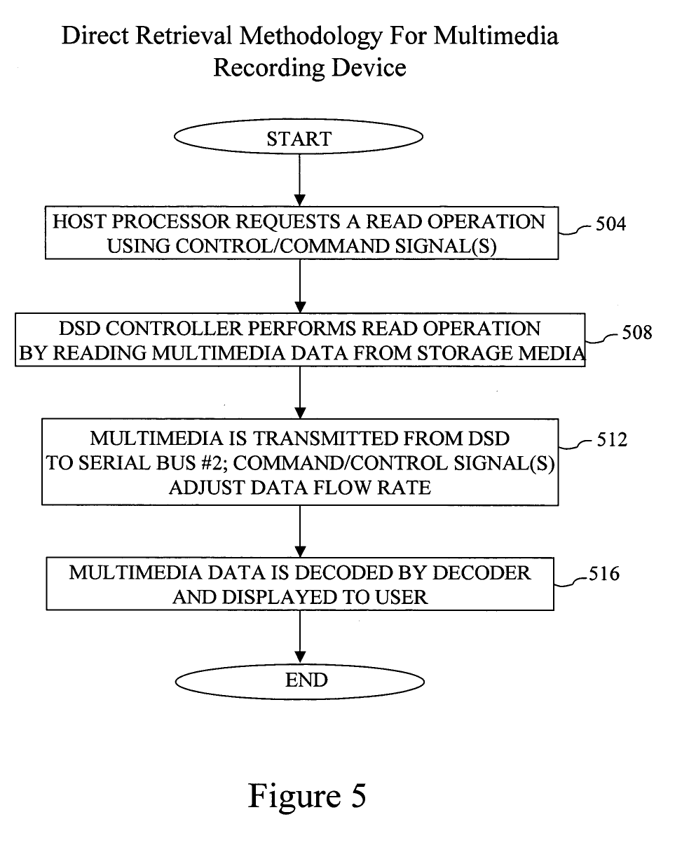

FIG. 5 is an operational flow diagram describing a direct retrieval methodology used by a multimedia recording device, in accordance with an embodiment of the invention. The direct retrieval methodology is used to playback a stored recording. The multimedia recording device may comprise a digital video recorder (DVR), for example. Referring back to FIG. 2, playback of multimedia data may occur, for example, when the data storage device (DSD) illustrated in FIG. 2 receives a read operation request by the host processor, as indicated at step 504. The read operation request may be facilitated by using the control/command signals. The request may be automatically generated, for example, when a user provides a relevant input or command. At step 508, multimedia data is read from the storage media by way of control from the DSD controller. Next, at step 512, the multimedia data is transmitted from the DSD by way of a bus (i.e., bus #2, FIG. 2) to a decoder of the DVR. The DSD controller may execute firmware to facilitate the reading of the multimedia data from the storage media. The firmware may reside within the DSD memory of the DSD controller. At step 516, the multimedia data is decoded and subsequently displayed to the user. The decoder may decompress the multimedia data such that it is capable of being properly presented to a display.

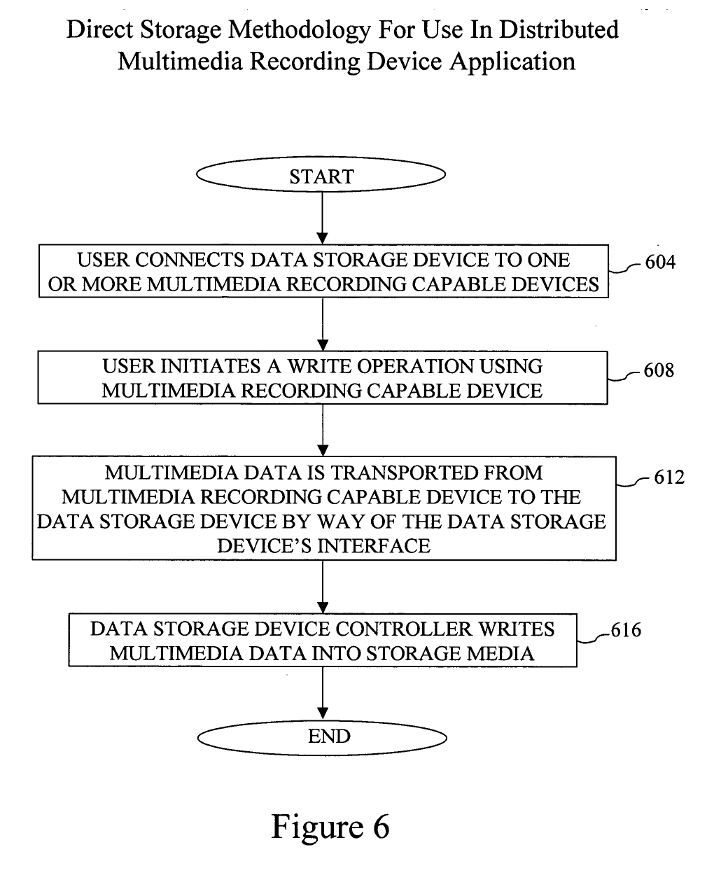

FIG. 6 is an operational flow diagram describing a direct storage methodology used in a distributed multimedia recording device application, for the system embodiment described in reference to FIG. 3, in accordance with an embodiment of the invention. At step 604, a user connects a data storage device to one or more multimedia recording capable devices. The one or more multimedia recording capable devices may comprise one or more DVR capable television sets, for example. The one or more multimedia recording capable devices may comprise one or more video camcorders, for example. Depending on the application, at step 608, the user initiates a write operation using the multimedia recording capable device. The user may input a command into a user interface to initiate the write operation. Next, at step 612, multimedia data is transported from the multimedia recording capable device to the data storage device. The data may be transmitted through the bypass interface (i.e., 328, FIG. 3) of the data storage device. Optionally, the command/control signals may be communicated through the bypass interface. The command/control signals may originate from a host processor of the multimedia recording capable device. Next, at step 616, the data storage device controller facilitates writing the multimedia data onto the storage media of the data storage device. The data storage device controller, as previously shown in FIG. 3, may execute firmware to facilitate writing of the multimedia data into the storage media. The firmware may reside within the DSD memory of the DSD controller.

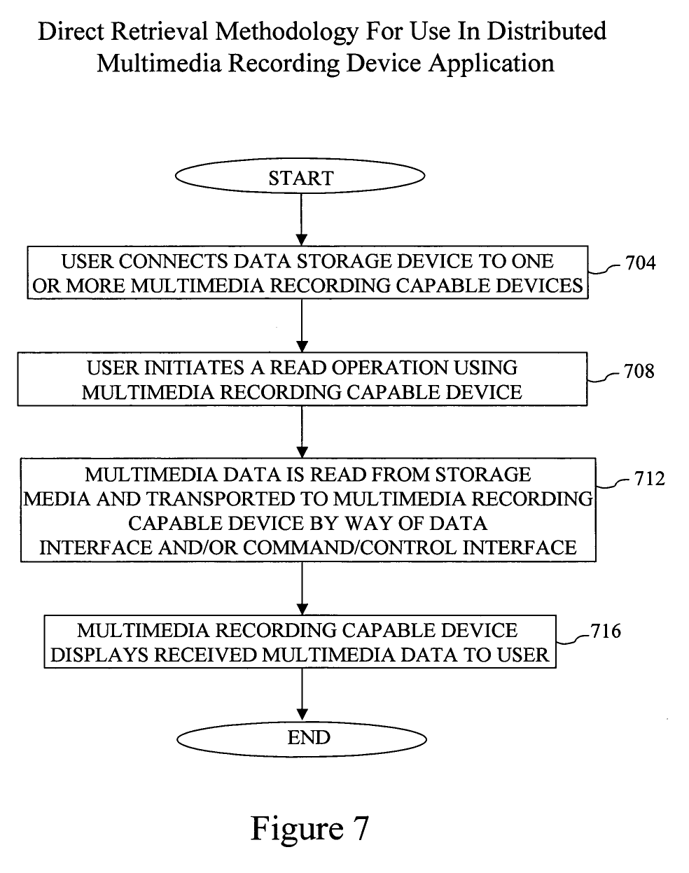

FIG. 7 is an operational flow diagram describing a direct retrieval methodology used in a distributed multimedia recording device application, for the system embodiment described in reference to FIG. 3, in accordance with an embodiment of the invention. The direct retrieval methodology is used to playback a stored recording. At step 704, a user connects a data storage device (as previously described in reference to FIG. 3) to one or more DVRs or multimedia recording devices. At step 708, the user initiates a read operation using the one or more DVRs or multimedia recording devices. The user may input a command into a user interface to initiate the read operation. The data storage device controller, shown in FIG. 3, may execute firmware to facilitate reading of the multimedia data from the storage media. The firmware may reside within the DSD memory of the data storage device controller, as previously described in reference to FIG. 3. Next, at step 712, multimedia data is read from the storage media of the data storage device and is transported from the data storage device to the DVR or multimedia recording device by way of the bypass interface (i.e., 328, FIG. 3) and the associated bus. At step 716, the DVR or multimedia recording device transmits the received multimedia data to a display for viewing by the user. The data storage device controller, shown in FIG. 3, may execute firmware to facilitate reading of the multimedia data from the data storage media. The firmware may reside within the DSD memory of the data storage device controller.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method of storing data into a multimedia recording device comprising:
receiving said data by said multimedia recording device; and
transmitting said data directly into a data storage device of said multimedia recording device without storing said data into a memory used as a data buffer by a processor of said multimedia recording device.

2. The method of claim 1 wherein said multimedia recording device comprises a digital video recorder (DVD).

3. The method of claim 1 wherein said data storage device comprises a hard disk drive.

4. The method of claim 1 wherein said data storage device comprises an optical reader/writer.

5. The method of claim 4 wherein said optical reader/writer comprises a DVD reader/writer.

6. The method of claim 1 wherein said memory comprises a random access memory.

7. A method of playing data from a data storage drive of a multimedia recording device comprising:
reading said data from said data storage device of said multimedia recording device; and
transmitting said data directly to a decoder of said multimedia recording device without storing said data into a memory used as a data buffer by a processor of said multimedia recording device, said decoder used to provide decoded data to a display.

8. The method of claim 7 wherein said multimedia recording device comprises a digital video recorder (DVD).

9. The method of claim 7 wherein said data storage device comprises a hard disk drive.

10. The method of claim 7 wherein said data storage device comprises an optical reader/writer.

11. The method of claim 10 wherein said optical reader/writer comprises a DVD reader/writer.

12. The method of claim 7 wherein said memory comprises a random access memory.

13. A method of storing data from one or more multimedia recording capable devices into a data storage device comprising:
receiving said data by said one or more multimedia recording capable devices; and
transmitting said data into said data storage device by way of connecting said data storage device to said one or more multimedia recording capable devices by way of using a bypass interface provided by said data storage device, said transmitting performed without using a processor memory of said one or more multimedia recording capable devices, said processor memory used as a data buffer for said data.

14. The method of claim 13 wherein said one or more multimedia recording capable devices comprises one or more DVR capable devices.

15. The method of claim 13 wherein said data storage device comprises a hard disk drive.

16. The method of claim 13 wherein said data storage device comprises an optical reader/writer.

17. The method of claim 13 wherein said one or more multimedia recording capable devices comprise one or more video camcorders.

18. The method of claim 13 wherein said bypass interface provides 802.3x transmission.

19. The method of claim 13 wherein said bypass interface provides 802.11 x or Bluetooth transmission.

20. The method of claim 13 wherein said bypass interface comprises one or more IEEE 1394 compliant connectors.

21. The method of claim 13 wherein said bypass interface comprises one or more USB compliant connectors.

22. The method of claim 13 wherein said bypass interface comprises one or more serial and/or parallel type of connectors.

23. A method of playing data from a data storage device to one or more multimedia recording capable devices comprising:
reading said data from said data storage device; and
transmitting said data to one or more decoders of said one or more multimedia recording capable devices by way of using a bypass interface provided by said data storage device, said transmitting performed without using a processor memory of said one or more multimedia recording capable devices, said processor memory used as a data buffer for said data, said decoder used to provide decoded data to a display.

24. The method of claim 23 wherein said one or more multimedia recording capable devices comprises one or more DVR capable devices.

25. The method of claim 23 wherein said data storage device comprises a hard disk drive.

26. The method of claim 23 wherein said data storage device comprises an optical reader/writer.

27. The method of claim 23 wherein said one or more multimedia recording devices comprises one or more video camcorders.

28. The method of claim 23 wherein said bypass interface provides 802.3x transmission.

29. The method of claim 23 wherein said bypass interface provides 802.11x or Bluetooth transmission.

30. The method of claim 23 wherein said bypass interface comprises one or more IEEE 1394 compliant connectors.

31. The method of claim 23 wherein said bypass interface comprises one or more USB compliant connectors.

32. The method of claim 23 wherein said bypass interface comprises one or more serial and/or parallel type of connectors.

33. A multimedia recording and playback system comprising:
a multimedia recording device used for receiving multimedia data;
a data storage device for storing and retrieving said multimedia data, said storing and said retrieving performed without using a processor memory of said multimedia recording device, wherein said processor memory is used as a buffer for said multimedia data.

34. The multimedia recording and playback system of claim 33 wherein said multimedia recording device comprises one or more serial buses used for directly transmitting said multimedia data between said multimedia recording device and said data storage device.

35. The multimedia recording and playback system of claim 33 wherein said multimedia recording device comprises said data storage device.

36. The multimedia recording and playback system of claim 33 wherein said data storage device transmits and receives said multimedia data and one or more command/control signals by way of a bypass interface.

37. The multimedia recording and playback system of claim 36 wherein said bypass interface provides 802.3x transmission

38. The multimedia recording and playback system of claim 36 wherein said bypass interface provides 802.11x or Bluetooth transmission.

39. The multimedia recording and playback system of claim 36 wherein said bypass interface comprises one or more serial and/or parallel type of connectors.
